(19) United States
(12) Patent Application Publication
(10) Pub. No.: US 2026/0111385 A1
(43) Pub. Date: Apr. 23, 2026

(54) PCIE DEVICE DETECTION SYSTEM, METHOD AND APPARATUS, AND PRODUCT

(71) Applicant: Suzhou MetaBrain Intelligent Technology Co., Ltd., Suzhou, Jiangsu (CN)

(72) Inventors: Yangyang GUO, Suzhou, Jiangsu (CN); Zhihua GE, Suzhou, Jiangsu (CN)

(21) Appl. No.: 19/469,517

(22) PCT Filed: Sep. 27, 2024
(86) PCT No.: PCT/CN2024/122031

§ 371 Date: Sep. 26, 2025

(30) Foreign Application Priority Data
Jan. 16, 2024 (CN) 202410063487.1

(51) Int. Cl. G06F 13/40; G06F 11/22

(52) U.S. Cl. CPC G06F 13/4081; G06F 11/2273; G06F 2213/0026

(57) ABSTRACT

The present application relates to the technical field of peripheral component interconnect express (PCIe) devices, and discloses a PCIe device detection system, method and apparatus, and a product. The PCIe device detection system at least includes a complex programmable logic device (CPLD), where the CPLD includes a control unit, configured to obtain presence information transmitted by a PCIe device during a detection cycle, the presence information including presence signals of all presence detection pins on the PCIe device; a parsing unit, configured to obtain all presence signals from the presence information, and determine an actual bandwidth of the PCIe device based on the presence signals; and a determination unit, configured to determine whether the PCIe device tilts according to a preset bandwidth and the actual bandwidth.

### CROSS-REFERENCE TO RELATED APPLICATION

This application claims priority to Chinese Patent Application No. 202410063487.1, filed on Jan. 16, 2024 in China National Intellectual Property Administration and entitled “PCIe Device Detection System, Method and Apparatus, and Product”, which is hereby incorporated by reference in its entirety.

### FIELD

The present application relates to the technical field of peripheral component interconnect express (PCIe) devices, and in particular, to a PCIe device detection system, method and apparatus, and a product.

### BACKGROUND

Peripheral Component Interconnect Express (PCIe) is a high-speed serial computer expansion bus standard. As a critical peripheral component for Internet connection, a PCIe device is widely deployed in a server. Taking a PCIe network interface card as an example, the PCIe network interface card is connected with a motherboard via slots to achieve high-speed data transmission and a network connection function, thereby meeting large-scale data processing and distributed computation requirements, and enhancing data transmission efficiency of the server. In a server application scene, the detection of device bandwidth reduction is an important part. In an environment with an extremely large number of servers such as a computer room, and a cluster, interference of PCIe network interface cards such as vibration and tilt caused by the assembly and replacement of the PCIe device, daily operation and maintenance of customer services or transportation is increasing. Especially for edge servers that are in a harsh environment for a long time, it is inevitable that the device may be disturbed due to force majeure factors, resulting in bandwidth reduction of the device, decrease of data transmission rates, and increase of transmission error rates, which may affect the interoperability of network devices.

Currently, the device bandwidth reduction is detected by a basic input/output system (BIOS). When the server is powered on, the BIOS may perform power-on self-check on the device. If abnormal bandwidth reduction occurs in the device, a reason for the bandwidth reduction needs to be determined, and tilting (poor contact) of the PCIe device is one of reasons for the bandwidth reduction. In a PCIe bus, a presence detection signal wire is connected to a presence detection pin of the PCIe device. When the pin is inserted into a slot and operates normally, a level of the pin may be pulled down, and a low level of the presence signal represents the presence (correct installation) of the device; and if the pin is not inserted properly or a fault occurs during the operation, the level of the pin may be pulled high, and a high level of the presence signal represents that the device is not present. When detecting whether the device tilts, the BIOS acquires the presence signal of the device, performs a wired-AND logic operation at a motherboard side, and then transmits a result to a baseboard management controller (BMC). Whether the device is present is determined by the BMC. However, when the PCIe device tilts, a situation where some presence signals are at a low level, and some presence signals are at a high level may occur. In this case, the wired-AND result may still be a low level. Consequently, the BMC may determine that the device is properly installed and may not generate an alarm prompt, whereby the tilt of the device might not be determined. In this case, the service operation needs to be stopped, and a server chassis needs to be opened to insert and remove the PCIe device again for troubleshooting. The server is in a closed mode during operation, and consequently the server chassis is difficult to open, and the PCIe device is difficult to remove and insert. Therefore, the manner is complicated in operation steps and low in efficiency. The operation for the edge server is more difficult, a large amount of time and cost may be wasted, and the normal operation of services may be severely affected.

### SUMMARY

In view of this, the present application aims at providing a peripheral component interconnect express (PCIe) device detection system, method and apparatus, and a product, to quickly detect whether a PCIe device tilts.

To realize the above purpose, the present application adopts the following technical solutions:

According to a first aspect of embodiments of the present application, provided is a peripheral component interconnect express device detection system, which at least includes a complex programmable logic device. The complex programmable logic device includes:
a control unit, configured to obtain presence information transmitted by a peripheral component interconnect express device during a detection cycle, the presence information including presence signals of all presence detection pins on the peripheral component interconnect express device;
a parsing unit, configured to obtain all presence signals from the presence information, and determine an actual bandwidth of the peripheral component interconnect express device based on the presence signals; and
a determination unit, configured to determine whether the peripheral component interconnect express device tilts according to a preset bandwidth and the actual bandwidth.

In some embodiments, the complex programmable logic device further includes a register, configured to store the presence information and the preset bandwidth; and
the parsing unit is further configured to determine a specification of the peripheral component interconnect express device according to a total number of the presence signals of the peripheral component interconnect express device; and take a factory bandwidth corresponding to the specification of the peripheral component interconnect express device as the preset bandwidth to be stored in the register.

In some embodiments, the parsing unit is in some embodiments configured to perform the following steps:
obtaining a number of low-level presence signals among all presence signals; and
calculating the actual bandwidth of the peripheral component interconnect express device according to the number of low-level presence signals, the total number of the presence signals, and the preset bandwidth.

In some embodiments, the determination unit is in some embodiments configured to perform the following steps:
comparing the actual bandwidth with the preset bandwidth; determining that the peripheral component interconnect express device is in a bandwidth reduction state if the actual bandwidth is less than the preset bandwidth; and determining that the peripheral component interconnect express device tilts if a high-level presence signal is detected, when the peripheral component interconnect express device is in the bandwidth reduction state.

In some embodiments, the control unit is configured to receive the presence information transmitted by the peripheral component interconnect express device during a plurality of consecutive detection cycles;
the parsing unit is configured to determine an actual bandwidth of the peripheral component interconnect express device during each detection cycle;
the determination unit is configured to compare the actual bandwidth of the peripheral component interconnect express device with the preset bandwidth during each detection cycle; determine that the peripheral component interconnect express device is in a bandwidth reduction state if the actual bandwidth is less than the preset bandwidth; and determine that the peripheral component interconnect express device tilts if a high-level presence signal is detected, when a duration during which the peripheral component interconnect express device is in the bandwidth reduction state reaches a first threshold.

In some embodiments, the control unit is further configured to generate a bandwidth alarm signal when the peripheral component interconnect express device is in the bandwidth reduction state; and generate a tilt release request signal when the peripheral component interconnect express device tilts.

In some embodiments, the complex programmable logic device further includes a fault lighting unit;
the control unit is further configured to generate a fault lighting signal when the peripheral component interconnect express device is in the bandwidth reduction state, and transmit the fault lighting signal to the fault lighting unit; and
the fault lighting unit is configured to trigger a lighting alarm at a corresponding position according to the fault lighting signal.

In some embodiments, the control unit is further configured to perform the following steps:
configuring a data acquisition instruction, the data acquisition instruction including a data load enable signal and a clock signal, the data acquisition instruction being configured for acquiring the presence information of the peripheral component interconnect express device; and
transmitting the data acquisition instruction to the peripheral component interconnect express device during one detection cycle, and receiving the presence information transmitted by the peripheral component interconnect express device.

In some embodiments, the peripheral component interconnect express device detection system further includes a baseboard management controller;
the control unit is further configured to store the bandwidth alarm signal and the tilt release request signal in the register; and
the baseboard management controller is configured to read the bandwidth alarm signal and the tilt release request signal from the register, and generate an alarm prompt.

In some embodiments, the baseboard management controller is further configured to read the bandwidth alarm signal, the tilt release request signal, and all presence signals corresponding to a current detection cycle from the register, and record a peripheral component interconnect express fault log.

According to a second aspect of the embodiments of the present application, provided is a peripheral component interconnect express device detection method, which is applied to the peripheral component interconnect express device detection system provided in the first aspect of the embodiments of the present application, and includes:
acquiring presence information of a peripheral component interconnect express device, the presence information including presence signals of all presence detection pins on the peripheral component interconnect express device;
obtaining all presence signals from the presence information, and determining an actual bandwidth of the peripheral component interconnect express device based on the presence signals; and
determining whether the peripheral component interconnect express device tilts according to a preset bandwidth and the actual bandwidth.

In some embodiments, the peripheral component interconnect express device detection method further includes:
determining a specification of the peripheral component interconnect express device according to a total number of presence signals of the peripheral component interconnect express device; and
obtaining a corresponding factory bandwidth according to the specification of the peripheral component interconnect express device, and taking the factory bandwidth as the preset bandwidth.

In some embodiments, the determining an actual bandwidth of the peripheral component interconnect express device based on the presence signals includes
obtaining a number of low-level presence signals among all presence signals; and
calculating the actual bandwidth of the peripheral component interconnect express device according to the number of low-level presence signals, the total number of the presence signals, and the preset bandwidth.

In some embodiments, the determining whether the peripheral component interconnect express device tilts according to a preset bandwidth and the actual bandwidth includes:
comparing the actual bandwidth with the preset bandwidth;
determining that the peripheral component interconnect express device is in a bandwidth reduction state if the actual bandwidth is less than the preset bandwidth; and
when the peripheral component interconnect express device is in the bandwidth reduction state, if a high-level presence signal is detected, determining that the peripheral component interconnect express device tilts.

In some embodiments, the determining whether the peripheral component interconnect express device tilts according to a preset bandwidth and the actual bandwidth includes:
obtaining an actual bandwidth of the peripheral component interconnect express device during a plurality of consecutive detection cycles;
comparing an actual bandwidth with the preset bandwidth during each detection cycle;
determining that the peripheral component interconnect express device is in a bandwidth reduction state if the actual bandwidth is less than the preset bandwidth;
when a duration during which the peripheral component interconnect express device is in the bandwidth reduction state reaches a first threshold, if a high-level presence signal is detected, determining that the peripheral component interconnect express device tilts.

In some embodiments, the peripheral component interconnect express device detection method further includes:
when it is determined that the peripheral component interconnect express device is in the bandwidth reduction state, generating a bandwidth alarm signal;
generating a tilt release request signal when the peripheral component interconnect express device tilts; and
generating an alarm prompt based on the bandwidth alarm signal and the tilt release request signal.

In some embodiments, the peripheral component interconnect express device detection method further includes:
when it is determined that the peripheral component interconnect express device is in the bandwidth reduction state, generating a fault lighting signal; and
triggering a lighting alarm at a corresponding position according to the fault lighting signal.

In some embodiments, the obtaining a total number of presence signals of the peripheral component interconnect express device includes:
configuring a data acquisition instruction, the data acquisition instruction including a data load enable signal and a clock signal, the data acquisition instruction being configured for acquiring the presence information of the peripheral component interconnect express device; and
transmitting the data acquisition instruction to the peripheral component interconnect express device during one detection cycle, and receiving the presence information transmitted by the peripheral component interconnect express device during the detection cycle, the presence information including presence signals of all presence detection pins on the peripheral component interconnect express device; and
determining the total number of presence signals of the peripheral component interconnect express device according to the presence information.

In some embodiments, the peripheral component interconnect express device detection method further includes:
recording a peripheral component interconnect express fault log according to the bandwidth alarm signal, the tilt release request signal, and all presence signals corresponding to a current detection cycle.

According to a third aspect of the embodiments of the present application, provided is a peripheral component interconnect express device detection apparatus, which is configured to implement the peripheral component interconnect express device detection method provided in the second aspect of the embodiments of the present application, and includes:
a signal acquisition module, configured to acquire presence information of a peripheral component interconnect express device, the presence information including presence signals of all presence detection pins on the peripheral component interconnect express device;
a bandwidth obtaining module, configured to obtain all presence signals from the presence information, and determine an actual bandwidth of the peripheral component interconnect express device based on the presence signals; and
a determination module, configured to determine whether the peripheral component interconnect express device tilts according to a preset bandwidth and the actual bandwidth.

According to a fourth aspect of the embodiments of the present application, provided is a non-transitory computer-readable storage medium, having a computer program stored therein, and the computer program, when executed by a processor, implementing the steps in the peripheral component interconnect express device detection method as described in the second aspect of the embodiments of the present application.

According to a fifth aspect of the embodiments of the present application, provided is an electronic device, which includes a memory, a processor, and a computer program stored on the memory and capable of running on the processor, the processor, when executing the computer program, implementing the steps in the peripheral component interconnect express device detection method as described in the second aspect of the embodiments of the present application.

By employing the peripheral component interconnect express device detection system provided by the present application, the presence information of a PCIe device is actively acquired by the complex programmable logic device (CPLD), and the current actual bandwidth of the PCIe device is determined based on all presence signals, and the preset bandwidth of the PCIe device is compared with the actual bandwidth, to determine whether the device has a problem of bandwidth reduction, and whether the PCIe device tilts. Compared with a traditional bandwidth reduction fault detection manner, by employing the present application, when the problem of bandwidth reduction occurs in the device, whether the device tilts might be determined quickly and accurately without removing a server chassis to insert and remove the PCIe device again, thereby significantly enhancing troubleshooting efficiency, reducing repair time, and reducing maintenance cost of the device.

### BRIEF DESCRIPTION OF THE DRAWINGS

To describe the technical solutions of the embodiments of the present application more clearly, the accompanying drawings required for describing the embodiments of the present application are introduced briefly below. Apparently, the accompanying drawings in the following description show only some embodiments of the present application, and a person of ordinary skill in the art may still derive other accompanying drawings from these accompanying drawings without creative efforts.

FIG. 1 is a schematic diagram of a peripheral component interconnect express (PCIe) device detection system according to an embodiment of the present application;

FIG. 2 is a schematic diagram of a hardware architecture of a PCIe device detection system according to an embodiment of the present application;

FIG. 3 is a flowchart of a PCIe device detection method according to an embodiment of the present application;

FIG. 4 is a flowchart of detecting whether a PCIe device tilts according to an embodiment of the present application;

FIG. 5 is a schematic diagram of a PCIe device detection apparatus according to an embodiment of the present application; and

FIG. 6 is a schematic structural diagram of an electronic device according to an embodiment of the present application.

### DETAILED DESCRIPTION

The technical solutions in embodiments of the present application are clearly and completely described in the following with reference to the accompanying drawings in the embodiments of the present application. Apparently, the described embodiments are some rather than all of the embodiments of the present application. Based on the embodiments of the present application, all other embodiments obtained by an ordinary skilled in the art without creative efforts shall fall within the protection scope of the present application.

It should be understood that the term “one embodiment” or “an embodiment” as used throughout the description refers to that particular features, structures, or characteristics associated with the embodiment are included in at least one embodiment of the present application. Therefore, “in one embodiment” or “in an embodiment” appearing throughout the description do not necessarily refer to the same embodiment. Furthermore, the particular features, structures, or characteristics may be combined into one or more embodiments in any suitable way.

It should be understood that, in various embodiments of the present application, the sequence numbers of the following processes do not mean the order of execution. The execution order of the processes should be determined by their functions and internal logic rather than constituting any limitation to the implementation process of the embodiments of the present application.

Exemplary embodiments are described in detail herein, and examples are shown in the accompanying drawings. When the following description involves the accompanying drawings, unless otherwise indicated, same numerals in different accompanying drawings represent the same or similar elements. The implementations described in the following exemplary embodiments do not represent all implementations consistent with the present application. On the contrary, the implementations are only examples of apparatuses and methods consistent with some aspects of the present application as claimed in claims.

It should be noted that, in the case of no conflict, the embodiments in the present application and the features in the embodiments might be combined.

In a traditional basic input/output system (BIOS) bandwidth reduction detection method, a BIOS at a motherboard side polls a peripheral component interconnect express (PCIe) device through a two-channel PCA9641 I2C-bus master arbiter. During a link establishment process between a central processing unit (CPU) and the PCIe device, a current actual available bandwidth of the PCIe device is obtained. An operator queries a factory theoretical bandwidth of the PCIe device based on a model specification of the PCIe device, then compares the theoretical bandwidth with the actual bandwidth read by the BIOS. If the two values do not match, the device is determined to have a problem of bandwidth reduction. However, there are multiple causes for bandwidth reduction, among which contact of the device accounts for an extremely high proportion, which is embodied in device tilt or interference from foreign matters in slots. The device tilt causes one end of a presence signal to contact the pin, and to be pulled down to a low level, while the other end fails to contact a slot pin due to tilt, resulting in the signal being pulled high. Ultimately, a wired-AND result of presence signals manifests as a low level. Since a baseboard management controller (BMC) reads the wired-AND result of all presence signals, the BMC may determine that the device is properly seated even when device tilt occurs. Therefore, in a traditional detection method, eliminating the factor of device tilt requires inserting and removing the device again, resulting in excessive troubleshooting overhead and operational cost waste.

A PCIe device detection system disclosed in the present application employs a register of a complex programmable logic device (CPLD) to directly read a PCIe presence signal and utilizes a self-determination mechanism to determine whether the device tilts without needing the BIOS for detection, and the baseboard management controller (BMC) does not need to obtain a wired-AND resource of the presence signal, thereby saving a link resource of an interaction link between the BIOS and the BMC and a slot, reducing wires deployed on a printed circuit board (PCB) and usage of logic and gate chips, and reducing the hardware cost.

The present application is described in detail below in conjunction with the accompanying drawings and embodiments.

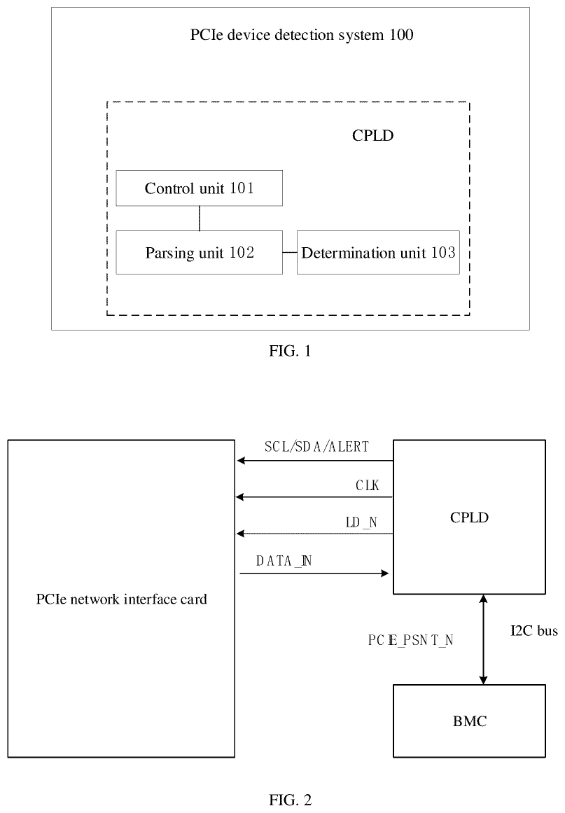

FIG. 1 is a schematic diagram of a peripheral component interconnect express (PCIe) device detection system 100 according to an embodiment of the present application. As shown in FIG. 1, the system 100 at least includes a CPLD. The CPLD includes:
a control unit 101, configured to obtain presence information transmitted by a PCIe device during a detection cycle, the presence information including presence signals of all presence detection pins on the PCIe device;
a parsing unit 102, configured to obtain all presence signals from the presence information, and determine an actual bandwidth of the PCIe device based on the presence signals; and
a determination unit 103, configured to determine whether the PCIe device tilts according to a preset bandwidth and the actual bandwidth.

In the present embodiment, the PCIe device detection system employs the CPLD to actively obtain internal presence signal data of the PCIe device, determines the current actual bandwidth of the PCIe device based on the presence signal, and determines whether the PCIe device tilts according to actual bandwidth data and the preset bandwidth. Using the parallel data processing advantage of the CPLD, the actual bandwidth of the PCIe device is compared with the preset bandwidth, and whether the device tilts is determined according to a self-determination mechanism. Compared with a power-on self-check method of the BIOS in a traditional method, the system might determine whether the PCIe tilts more quickly and accurately.

As an implementation of the present application, the CPLD further includes a register, configured to store the presence information and the preset bandwidth; and
the parsing unit is further configured to determine a specification of the PCIe device according to a total number of presence signals of the PCIe device; and take a factory bandwidth corresponding to the specification of the PCIe device as the preset bandwidth to be stored in the register.

In an embodiment, the parsing unit obtains the presence signals from the presence information, and determines the specification of the PCIe device according to the number of the presence signals. The diversification of server products supports more types of PCIe. Taking a PCIe network interface card as an example, the PCIe network interface card includes an NIC, HCA, HBA, CAN, and other types. The conventional PCIe network interface card mainly includes specifications such as PCIe X1, PCIe X2, PCIe X4, PCIe X8, and PCIe X16. Different specifications of the PCIe network interface cards correspond to different numbers of channels and bandwidth support. For example, an X8 PCIe network interface card has four presence signals, and a bandwidth corresponds to the X8 PCIe network interface card is 3814.72 MB/s. In the present embodiment, the parsing unit may determine the specification (such as X8) of the PCIe device according to the total number (for example, the total number is 4) of the presence signals, further obtains the factory bandwidth of the device, and takes the factory bandwidth as the present bandwidth to be stored in the register.

In some embodiments, in an embodiment, to improve the detection efficiency, the total number of the presence signals and the corresponding factory bandwidth data may be determined in advance according to a model number of the PCIe device used in a server, and a bandwidth query table may be established, the parsing unit obtains the total number of the presence signals from the presence information, finds the corresponding bandwidth data in the bandwidth query table according to the total number of the presence signals, and takes the bandwidth data as the preset bandwidth data to be stored in the register.

As an implementation of the present application, the parsing unit is in some embodiments configured to perform the following steps:
obtaining a number of low-level presence signals among all presence signals; and
calculating the actual bandwidth of the PCIe device according to the number of low-level presence signals, the total number of the presence signals, and the preset bandwidth.

In the present embodiment, the CPLD obtains level information of the presence signals of the PCIe device in a polling manner, and calculates the actual bandwidth according to the high and low levels. The low-level presence signal represents that the presence detection pin corresponding to the presence signal might be operated normally, and the high-level presence signal represents that the presence detection pin corresponding to the presence signal has a fault, and might not be operated normally. Among the presence signals of the PCIe device, the number of low-level signals has a proportional relationship with the actual bandwidth of the PCIe device, while the number of high-level signals has a proportional relationship with a bandwidth loss. Therefore, by determining the number of low-level presence signals among the current presence signals of the PCIe device, the current actual bandwidth of the PCIe device might be calculated according to the total number of the presence signals and the preset bandwidth of the device.

In some embodiments, the actual bandwidth of the PCIe device may be calculated by employing the following expression:

Actual bandwidth=(number of low-level presence signals+total number of presence signals)×theoretical bandwidth value.

For example, when the PCIe device with a specification of X8 is detected, the total number of the presence signals obtained is 4, where three presence signals are at a low level, and one presence signal is at a high level. In this case, based on the factory bandwidth value of 3814.72 MB/s for the X8 device, the actual bandwidth of the device may be calculated as: (3÷4)×3814.72=2861.04 MB/s.

In the present embodiment, after calculating the current actual bandwidth of the device, the parsing unit stores the actual bandwidth data in the register for reading.

As an implementation of the present application, the determination unit is in some embodiments configured to perform the following steps:
comparing the actual bandwidth with the preset bandwidth; determining that the PCIe device is in a bandwidth reduction state if the actual bandwidth is less than the preset bandwidth; and determining that the PCIe device tilts if a high-level presence signal is detected, when the PCIe device is in the bandwidth reduction state.

In the present embodiment, the parallel data processing feature of the CPLD is utilized, the determination unit reads the preset bandwidth data and current actual bandwidth data of the PCIe device from the register, and then compares the two bandwidth data to determine whether the PCIe device has a problem of bandwidth reduction. If the current actual bandwidth is less than the preset bandwidth, it is determined that the device is in the bandwidth reduction state. In this case, if the high-level presence signal is detected, the problem of bandwidth reduction may be determined to be caused by the device tilt. In the present embodiment, by utilizing the parallel processing advantages of internal modules of the CPLD, quick comparison between the preset bandwidth and the actual bandwidth and determination of device tilt might be achieved.

As an implementation of the present application, the control unit is configured to receive presence information transmitted by the PCIe device during a plurality of consecutive detection cycles;
the parsing unit is configured to determine an actual bandwidth of the PCIe device during each detection cycle; and
the determination unit is configured to compare the actual bandwidth with the preset bandwidth during each detection cycle; determine that the PCIe device is in a bandwidth reduction state if the actual bandwidth is less than the preset bandwidth; and determine that the PCIe device tilts if the high-level presence signal is detected, when a duration during which the PCIe device is in the bandwidth reduction state reaches a first threshold.

In an embodiment, a plurality of consecutive rounds of detection are performed on the PCIe device, during each detection cycle, the presence signals of the device are obtained from the presence information, and the actual bandwidth in a current detection cycle is calculated according to the high and low levels of the presence signals, the total number of the presence signals, and the preset bandwidth. The actual bandwidth acquired through multiple consecutive detection rounds is compared with the preset bandwidth. If the duration or number of cycles during which the PCIe device remains in the bandwidth reduction state reaches a specific threshold, the device is determined to have the problem of bandwidth reduction. In this case, determination is performed according to the level of the presence signals, and if the high-level presence signal is detected, the problem of bandwidth reduction may be determined to be caused by the device tilt.

In some embodiments, in the present embodiment, the first threshold may be set correspondingly according to an actual application situation, for example, may be set according to the number of cycles, or may be set in seconds.

In the present embodiment, whether the device has bandwidth reduction is determined during a plurality of consecutive detection cycles, to further determine whether the device tilt occurs. Determination is performed only after the device remains in the bandwidth reduction state for a sustained duration, thereby ensuring that bandwidth fluctuation within a short period of time do not cause false determination or frequent alarms.

As an implementation of the present application, the control unit is further configured to generate a bandwidth alarm signal when the PCIe device is in the bandwidth reduction state; and generate a tilt release request signal when the PCIe device tilts.

In an embodiment, when it is determined that the PCIe device is in the bandwidth reduction state, the control unit generates the bandwidth alarm signal, and generates the tilt release request signal when determining that the device is in a tilt state. The generated bandwidth reduction alarm signal and tilt release request signal are stored in the register for reading. Content included in both the bandwidth alarm signal and the tilt release request signal may be set according to actual requirements. For example, the bandwidth alarm signal may include an identification number (ID) of a server in which the device with the bandwidth reduction problem is located, a position of a slot in which the device is located, and the like; and the tilt release request signal may include an ID of the device that tilts, a device model number, a device specification, a position of a presence detection pin that tilts, and a position of the slot in which the device is located. By generating the bandwidth alarm signal and the tilt release request signal, an administrator may be promptly notified to perform fault handling.

As an implementation of the present application, the CPLD further includes a fault lighting unit;
the control unit is further configured to generate a fault lighting signal when the PCIe device is in the bandwidth reduction state, and transmit the fault lighting signal to a fault lighting unit; and
the fault lighting unit is configured to trigger a lighting alarm at a corresponding position according to the fault lighting signal.

In an embodiment, to more intuitively alarm the tilting device, the system further includes the fault lighting unit. The fault lighting unit alarms a presence detection pin corresponding to a high-level presence signal with poor contact according to the bandwidth alarm signal. In some embodiments, an alarm light may be configured on the server, and the bandwidth reduction alarm is triggered by turning on the alarm light.

In an embodiment, a plurality of alarm lights may also be configured, and configured to trigger the bandwidth reduction alarm and the tilt release request prompt. In the present embodiment, the lighting alarm is triggered for the device with the bandwidth reduction through the fault lighting unit, thereby more intuitively prompting a fault type and a fault position, facilitating the administrator to perform device maintenance and fault handling, and improving the processing efficiency.

As an implementation of the present application, the control unit is further configured to perform the following steps:
configuring a data acquisition instruction, the data acquisition instruction including a data load enable signal and a clock signal, the data acquisition instruction being configured for acquiring the presence information of the PCIe device; and
transmitting the data acquisition instruction to the PCIe device during one detection cycle, and receiving the presence information transmitted by the PCIe device.

In the present embodiment, customized data acquisition instruction enables the CPLD to serve as a MASTER that drives the instruction to acquire the presence information from the PCIe device. The data acquisition instruction includes the data load enable signal and the clock signal. The PCIe device is controlled to begin transmitting the presence information during the detection cycle through the data load enable signal, and a data transmission frequency of the PCIe device is controlled through the clock signal.

In the present embodiment, a data transmission signal is further defined in a data acquisition process, the PCIe device returns presence signal data to the CPLD based on the data transmission signal, where the presence signal is represented by the high and low levels, and one presence signal occupies 1 bit.

In an embodiment, the present application further defines a fault lighting control signal, including an alarm control signal and a positioning signal. The position of the alarm light that needs to be turned on or off is determined by the positioning signal, and the alarm light is controlled to be turned on or off through the alarm control signal, thereby achieving flexible alarm control for the PCIe device.

As an implementation of the present application, the PCIe device detection system further includes a baseboard management controller;
the control unit is further configured to store the bandwidth alarm signal and the tilt release request signal in the register; and
the baseboard management controller is configured to read the bandwidth alarm signal and the tilt release request signal from the register, and generate an alarm prompt.

In an embodiment, the PCIe device detection system further includes the baseboard management controller (BMC), and implements remote monitoring and alarm prompt for the detection of the PCIe device through the BMC. In the present embodiment, the CPLD stores the bandwidth alarm signal and the tilt release request signal in the register, the BMC regularly reads the signal from the register of the CPLD; and when the bandwidth alarm signal and the tilt release request signal are read, a corresponding alarm prompt is generated and displayed in a management interface, whereby the administrator might locate a fault rapidly, and perform troubleshooting in time, thereby reducing the fault repair time, saving the cost, and enhancing the fault handling efficiency.

According to the alarm prompt, the administrator might conveniently perform remote monitoring on the device fault. When the problem of bandwidth reduction occurs, relevant information of the device with the fault might be quickly obtained through the alarm prompt, thereby improving the fault handling efficiency.

FIG. 2 is a schematic diagram of a hardware architecture of a PCIe device detection system according to an embodiment of the present application. As shown in FIG. 2, the PCIe device detection system includes a CPLD and a BMC. The CPLD performs data acquisition control by employing a data load enable signal LD_N, and a clock signal CLK, and a PCIe network interface card transmits presence information to the CPLD through a data transmission signal DATA_IN. The CPLD obtains all presence signals from the presence information through internal modules, determines a preset bandwidth and a current actual bandwidth of the device based on the presence signal, and further determines whether bandwidth reduction occurs in the device. When the bandwidth reduction occurs in the device, a generated bandwidth alarm signal and a tilt release request signal are stored in a register, and read by the BMC from the register through an I2C bus for parsing, and an alarm prompt is generated to promptly notify the administrator to perform a tilt release operation on the PCIe device in time to restore the normal operation of the device. When the bandwidth reduction occurs in the device, an alarm light is turned on through a fault lighting control signal. In some embodiments, positioning is performed through an SCL/SDA signal, and then the alarm light is controlled to be turned on through an alert signal. The SCL/SDA positioning signal may be configured according to an actual requirement. For example, the SCL signal may be configured as the positioning signal for turning on the alarm light, and the SDA signal may be configured as the positioning signal for turning off the alarm light.

In the present application, the CPLD actively acquires internal presence signal data from the PCIe device through the customized data acquisition signal and the data transmission signal, and generates register data containing the preset bandwidth and real-time bandwidth of the device during the detection cycle, allowing the BMC to read via the I2C bus and record the fault log. When whether the bandwidth reduction occurs or device tilt occurs is determined, the parallel data processing advantage of the CPLD is utilized to integrate and compare two sets of bandwidth data (preset bandwidth data and actual bandwidth data). Based on the self-determination mechanism of the CPLD, a determination result is acquired, and the bandwidth alarm signal, the tilt release request signal, and the fault lighting signal are generated to trigger the alarm lights at positions corresponding to the presence signals, thereby more intuitively displaying a position of the high-level presence signal with the fault.

Since direct information interaction is performed between the BMC and the CPLD in the present embodiment, a wired-AND result of the presence signal does not need to be transmitted to the BMC through the BIOS for determination, thereby reducing wires deployed on a printed circuit board (PCB) in the traditional method and usage of logic and gate chips, and reducing the hardware cost.

As an implementation of the present application, the baseboard management controller is further configured to read the bandwidth alarm signal, the tilt release request signal, and all presence signals corresponding to a current detection cycle from the register, and record the PCIe fault log.

In an embodiment, the parsing unit is further configured to store the presence signals in the register of the CPLD, the BMC reads the presence signal of each presence detection pin in the PCIe device from the register, to obtain an operation state of each presence detection pin, thereby accurately knowing an operation situation of each presence detection pin by obtaining the presence signal (at a high level or a low level) of each pin. The high-level presence signal represents that the presence detection pin corresponding to the presence signal has poor contact. The BMC records the PCIe fault log according to the operation condition of the presence detection pin corresponding to each presence signal. As shown in FIG. 2, PCIe_PSNT_N is an example of the presence signal of the PCIe device. In the present application, the parsing unit stores all presence signals during the detection cycle in the register, and the BMC reads the presence signals from the register through the I2C bus to obtain the operation condition of each presence detection pin.

In the present embodiment, the BMC reads the presence signals, the bandwidth alarm signal, and the tilt release request signal, and records a tilt log of the PCIe device based on the read signal, to perform remote fault monitoring and historical fault record for the PCIe device, whereby the administrator might check whether the bandwidth reduction problem is caused by the device tilt through the log, and the administrator might evaluate an operation condition of the PCIe device by viewing the historical log.

In the present application, the readable presence signal data provides more accurate and detailed presence information compared to the traditional wired-AND method. The administrator might remotely determine the device tilt fault directly through a BMC interface, or intuitively locate a specific fault position through the fault alarm light at a specific position, thereby enhancing the management flexibility and practicality of the PCIe device, and improving efficiency for handling the device bandwidth reduction problem.

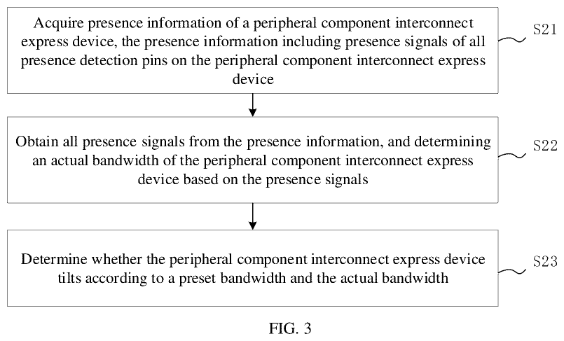

Based on a same inventive concept, an embodiment of the present application further provides a PCIe device detection method. Referring to FIG. 3, FIG. 3 is a flowchart of a PCIe device detection method according to an embodiment of the present application. As shown in FIG. 3, the method includes:
S21: acquiring presence information of a peripheral component interconnect express (PCIe) device, the presence information including presence signals of all presence detection pins on the peripheral component interconnect express device;
S22: obtaining all presence signals from the presence information, and determining an actual bandwidth of the peripheral component interconnect express device based on the presence signals; and
S23: determining whether the peripheral component interconnect express device tilts according to a preset bandwidth and the actual bandwidth.

As an implementation of the present application, the PCIe device detection method further includes:
determining a specification of the PCIe device according to a total number of the presence signals of the PCIe device; and
obtaining a corresponding factory bandwidth according to the specification of the PCIe device, and taking the factory bandwidth as the preset bandwidth.

As an implementation of the present application, the determining an actual bandwidth of the PCIe device based on the presence signals includes:
obtaining a number of low-level presence signals among all presence signals; and
calculating the actual bandwidth of the PCIe device according to the number of low-level presence signals, the total number of the presence signals, and the preset bandwidth.

As an implementation of the present application, the determining whether the PCIe device tilts according to a preset bandwidth and the actual bandwidth includes:
comparing the actual bandwidth with the preset bandwidth;
determining that the PCIe device is in a bandwidth reduction state if the actual bandwidth is less than the preset bandwidth; and
determining that the PCIe device tilts if a high-level presence signal is detected when the PCIe device is in the bandwidth reduction state.

As an implementation of the present application, the determining whether the PCIe device tilts according to a preset bandwidth and the actual bandwidth includes:
obtaining an actual bandwidth of the PCIe device during a plurality of consecutive detection cycles;
comparing an actual bandwidth with the preset bandwidth during each detection cycle;
determining that the PCIe device is in the bandwidth reduction state if the actual bandwidth is less than the preset bandwidth; and
determining that the PCIe device tilts if a high-level presence signal is detected when a duration during which the PCIe device is in the bandwidth reduction state reaches a first threshold.

As an implementation of the present application, the PCIe device detection method further includes:
generating a bandwidth alarm signal when it is determined that the PCIe device is in the bandwidth reduction state;
generating a tilt release request signal when the PCIe device tilts; and
generating an alarm prompt based on the bandwidth alarm signal and the tilt release request signal.

As an implementation of the present application, the PCIe device detection method further includes:
generating a fault lighting signal when it is determined that the PCIe device is in the bandwidth reduction state; and
triggering a lighting alarm at a corresponding position according to the fault lighting signal.

As an implementation of the present application, the obtaining a total number of the presence signals of the PCIe device includes:
configuring a data acquisition instruction, the data acquisition instruction including a data load enable signal and a clock signal, the data acquisition instruction being configured for acquiring the presence information of the PCIe device; and
transmitting the data acquisition instruction to the PCIe device during one detection cycle, and receiving the presence information transmitted by the PCIe device during the detection cycle, the presence information including presence signals of all presence detection pins on the PCIe device; and
determining the total number of presence signals of the PCIe device according to the presence information.

As an implementation of the present application, the PCIe device detection method further includes:
recording a PCIe fault log according to the bandwidth alarm signal, the tilt release request signal, and all presence signals corresponding to a current detection cycle.

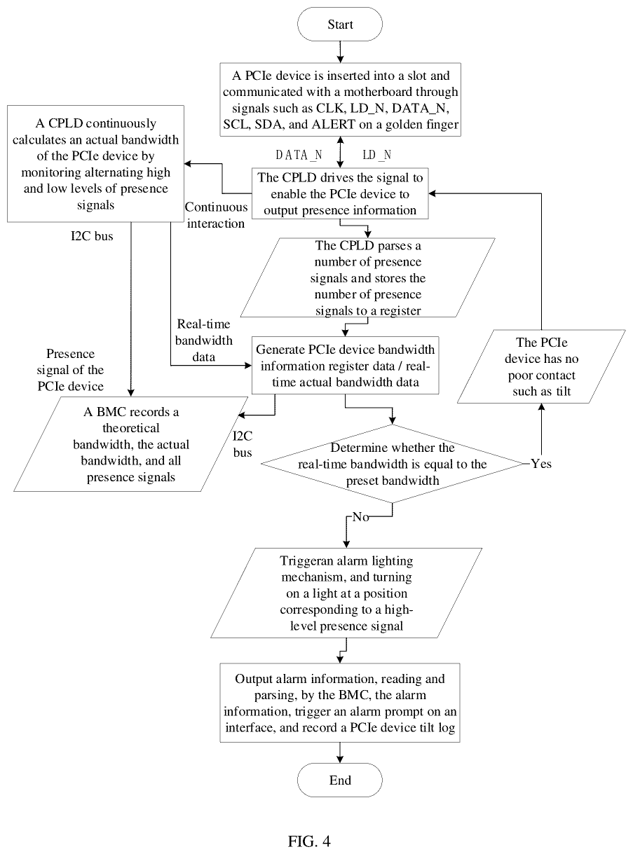

FIG. 4 is a flowchart of detecting whether a PCIe device tilts according to an embodiment of the present application. As shown in FIG. 4, the present embodiment implements tilt detection and remote monitoring for a PCIe device based on a CPLD and a BMC, and includes the following specific steps:
(1) In an initial state, a data load enable signal LD_N is at a high level, and a clock signal CLK is at a low level. A cycle T of a clock is set.
(2) Acquisition of presence information data is started; and the CPLD pulls LD_N low, and then pulls the signal high after generating a low pulse with a pulse width of T, to trigger the PCIe device to load latest presence state information; and during a period when LD_N is pulled to the low level, the CLK signal remains at a low level. Taking an X8 PCIe device as an example, the X8 device has four presence signals, as shown in Table 1 below. When the acquired presence signals 0, 1, and 2 are all at a low level, the presence signal 3 is at a high level.
(3) After a time period of T/2, the CPLD pulls the CLK high to generate a rising edge. The PCIe device then transmits a total number of internal presence signals and state data of all presence signals to a DATA_IN signal on the rising edge of the CLK signal. After a time period of T/2, the CPLD pulls the CLK signal low to generate a falling edge. Then, data transmitted by the PCIe device to the DATA_IN signal is stabilized. The CPLD then acquires data on a DATA_IN signal wire, and takes the data as a bit of data in a frame. The data acquisition operation is repeated according to the clock (CLK) cycle to obtain all presence information of the PCIe device. Results are shown in Table 1 below. In Table 1, Bit0 to Bit3 represent the four presence signals acquired during one detection cycle, which correspond to the presence signals PRSNTB0_N to PRSNTB3_N of the PCIe device respectively. Bit4 represents a wake-up signal of the CPLD.

TABLE 1

| Bit0 | Bit1 | Bit2 | Bit3 |
|---|---|---|---|
| PRSNTB0_N | PRSNTB1_N | PRSNTB2_N | PRSNTB3_N |

(4) After the PCIe device transmits the presence signals, the CPLD simultaneously acquires a final bit of data and regenerates a low pulse signal on the LD_N signal to initiate a next detection cycle, commencing a new round of presence information acquisition.
(5) The CPLD compares the total number of presence signals with an internal register logic and determines the specification of the PCIe device according to a mapping relationship. In some embodiments, a presence signal number of 1 maps to a PCIe device bandwidth of X1; a presence signal number of 2 maps to a PCIe device bandwidth of X4; a presence signal number of 4 maps to a PCIe device bandwidth of X8; and a presence signal number of 8 maps to a PCIe device bandwidth of X16. In practical applications, the used specification information of the device might be pre-stored in the register. The present application does not limit this. Taking the X8 device as an example, the bandwidth of the device is determined to be X8, i.e., 3814.72 MB/s according to the acquired total number of presence signals that is 4. Further, the actual bandwidth is calculated as 2861.04 Mb/s according to the high and low levels of each presence signal acquired by the CPLD. Through comparison, the actual bandwidth is less than the factory bandwidth 3814.72 Mb/s of the X8 device, whereby it is determined that the PCIe device has the bandwidth reduction.
(6) Based on a bandwidth reduction determination result, the CPLD generates a bandwidth alarm signal. After determining that the presence signal 3 (PRSNTB2_N) is at a high level, it is determined that the PCIe device tilts, and a tilt release request signal is generated. According to the bandwidth alarm signal, a lighting module at a corresponding position of the presence signal 3 is turned on. The CPLD forms the generated signal and the previously acquired presence signal into a frame of data. As shown in Table 2, in a frame of data, Bit5 to Bit7 are respectively the bandwidth alarm signal, the tilt release request signal, and the fault lighting signal.

TABLE 2

| Bit0 | Bit1 | Bit2 | Bit3 |
|---|---|---|---|
| PRSNTB0_N | PRSNTB1_N | PRSNTB2_N | PRSNTB3_N |

| Bit4 | Bit5 | Bit6 | Bit7 |
|---|---|---|---|
| WAKE_N | bandwidth_WARN_N | Release_tilt_CRIT_N | LED_ON_AUX |

(7) The CPLD stores the generated alarm signal and the tilt release request signal in the register, the BMC reads the signal from the register of the CPLD through the I2C bus and parses the signal, records a fault log, generates an alarm prompt, and displays the alarm prompt through a management interface. The administrator might quickly know the alarm information of the PCIe device and handle the alarm information in time through the management interface of the BMC.
(8) The CPLD outputs all presence signals according to the following logic, and stores the presence signals in the register:

$$PCIE\_PSNT \_N = PRSNTB 0 \_N \&\& PRSNTB 31 \_N \&\& PRSNTB 2 \_N \&\& PRSNTB 3 \_N$$

The BMC reads the signals from the register of the CPLD through the I2C bus and parses the signals. This method is also compatible with the original PCIe device presence detection process of the BMC. The BMC parses and records a device bandwidth log, and the administrator may read the device bandwidth log to monitor whether the PCIe device is well connected.

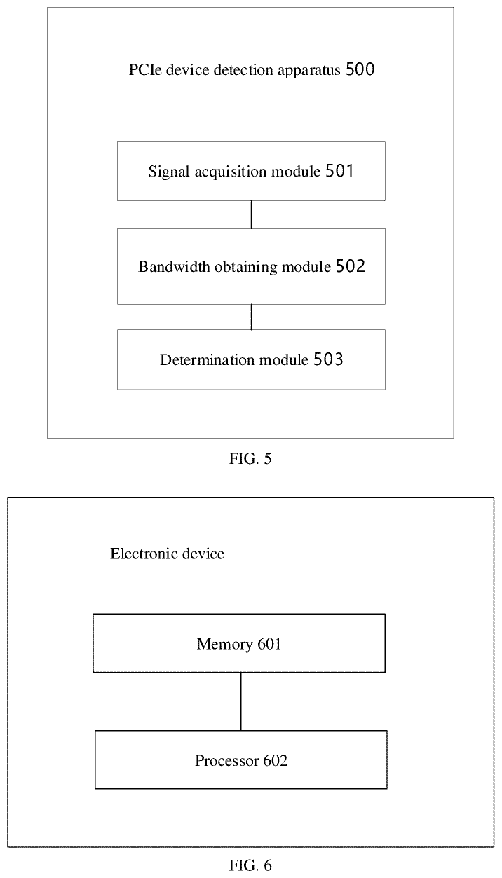

Based on a same inventive concept, an embodiment of the present application provides a PCIe device detection apparatus. Referring to FIG. 5, FIG. 5 is a schematic diagram of a PCIe device detection apparatus 500 according to an embodiment of the present application. As shown in FIG. 5, the apparatus includes:
a signal acquisition module 501, configured to acquire presence information of a PCIe device, the presence information including presence signals of all presence detection pins on the PCIe device;
a bandwidth obtaining module 502, configured to obtain all presence signals from the presence information, and determine an actual bandwidth of the PCIe device based on the presence signals; and
a determination module 503, configured to determine whether the PCIe device tilts according to a preset bandwidth and the actual bandwidth.

As an implementation of the present application, the bandwidth obtaining module 502 is further configured to determine a specification of the PCIe device according to a total number of presence signals of the PCIe device; and obtain a corresponding factory bandwidth according to the specification of the PCIe device, and take the factory bandwidth as the preset bandwidth.

As an implementation of the present application, the bandwidth obtaining module 502 is configured to perform the following steps:
obtaining a number of low-level presence signals among all presence signals; and
calculating the actual bandwidth of the PCIe device according to the number of low-level presence signals, the total number of the presence signals, and the preset bandwidth.

As an implementation of the present application, the bandwidth obtaining module 502 is configured to perform the following steps:
comparing the actual bandwidth with the preset bandwidth;
determining that the PCIe device is in a bandwidth reduction state if the actual bandwidth is less than the preset bandwidth; and
determining that the PCIe device tilts if a high-level presence signal is detected when the PCIe device is in the bandwidth reduction state.

As an implementation of the present application, the bandwidth obtaining module 502 is further configured to perform the following steps:
obtaining an actual bandwidth of the PCIe device during a plurality of consecutive detection cycles;
comparing an actual bandwidth with the preset bandwidth during each detection cycle;
determining that the PCIe device is in the bandwidth reduction state if the actual bandwidth is less than the preset bandwidth; and
determining that the PCIe device tilts if a high-level presence signal is detected when a duration during which the PCIe device is in the bandwidth reduction state reaches a first threshold.

As an implementation of the present application, the PCIe device detection apparatus 500 further includes an output module, configured to perform the following steps:
generating a bandwidth alarm signal when it is determined that the PCIe device is in the bandwidth reduction state;
generating a tilt release request signal when the PCIe device tilts; and
generating an alarm prompt based on the bandwidth alarm signal and the tilt release request signal.

As an implementation of the present application, the PCIe device detection apparatus 500 further includes an alarm module;
the output module is further configured to generate a fault lighting signal when determining that the PCIe device is in the bandwidth reduction state; and
the alarm module is configured to trigger a lighting alarm at a corresponding position according to a fault lighting signal.

As an implementation of the present application, the signal acquisition module 501 is further configured to perform the following steps: configuring a data acquisition instruction, the data acquisition instruction including a data load enable signal and a clock signal, and the data acquisition instruction being configured for acquiring the presence information of the PCIe device; and transmitting the data acquisition instruction to the PCIe device during one detection cycle, and receiving the presence information transmitted by the PCIe device during the detection cycle, the presence information including presence signals of all presence detection pins on the PCIe device; and
the bandwidth obtaining module 502 is further configured to determine a total number of presence signals of the PCIe device according to the presence information.

As an implementation of the present application, the PCIe device detection apparatus 500 further includes a recording module, which is configured to perform the following steps:
recording a PCIe fault log according to the bandwidth alarm signal, the tilt release request signal, and all presence signals corresponding to a current detection cycle.

Based on a same inventive concept, an embodiment of the present application provides a non-transitory readable storage medium, having a computer program stored therein, the program, when executed by a processor, performing the steps in the PCIe device detection method as described in any of the above embodiments.

Based on a same inventive concept, an embodiment of the present application provides an electronic device. Referring to FIG. 6, the electronic device includes a memory 601, a processor 602, and a computer program stored on the memory and capable of running on the processor, the processor, when executing the computer program, implementing the steps in the PCIe device detection method as described in any of the above embodiments.

Specific operation execution manners of the modules in the apparatus in the foregoing embodiment have been described in detail in the embodiments about the method, and details will not be described herein again.

The above description is only some embodiments of the present application and is not intended to limit the present application. Any modifications, equivalent substitution and improvements made within the spirit and principles of the present application shall be contained within the protection scope of the present application.

For ease of description, the method embodiments are described as a series of action combinations. However, a person skilled in the art knows that the present application is not limited to the described order of the actions because some operations may be performed in another order or performed at the same time according to the present application. In addition, a person skilled in the art is further to learn that the embodiments described in the present specification are all embodiments of the present application, and the involved actions and components are not necessarily required in the present application.

It should be understood by those skilled in the art that the embodiments of the present application might be provided as a method, an apparatus, or a computer program product. Therefore, the present application might take the form of an entirely hardware embodiment, an entirely software embodiment, or an embodiment combining software and hardware aspects. Moreover, the embodiments of the present application may use a form of a computer program product that is implemented on one or more non-transitory computer-readable storage media (including but not limited to a disk memory, a CD-ROM, an optical memory, and the like) that include a computer-usable program code.

The embodiments of the present application are described with reference to flowcharts and/or block diagrams of the method, the terminal device (system), and the computer program product of the present embodiments according to the embodiments of the present application. It should be noted that each flow and/or block in the flowchart and/or the block diagram, and a combination of the flow and/or block in the flowchart and/or the block diagram may be implemented by a computer program instruction. These computer program instructions may be provided to a processor of a general purpose computer, a dedicated computer, an embedded processing machine or other programmable data processing devices, to produce a machine, such that the instructions executed by the processor of the computer or other programmable data processing terminal device create an apparatus for implementing the functions specified in one or more flows of the flowchart and/or one or more blocks of the block diagram.

These computer program instructions may also be stored in a computer readable memory capable of instructing the computer or other programmable data processing terminal device to work in a specified manner, whereby the instructions stored in the computer readable memory create a product including the instruction apparatus, and the instruction apparatus implements the functions specified in one or more flows of the flowchart or in one or more blocks of the block diagram.

These computer program instructions might also be loaded on the computer or other programmable data processing terminal device, whereby a series of operation steps are performed on the computer or other programmable terminal device to produce computer-implemented processes, and subsequently, the instructions executed on the computer or other programmable terminal device provide steps for implementing the functions specified in one or more flows of the flowchart and/or in one or more blocks of the block diagram.

Although the embodiments of the present application have been described, those skilled in the art might make additional changes and modifications to these embodiments once they know the basic inventive concepts. Therefore, the appended claims are intended to be interpreted as including the embodiments and all changes and modifications falling within the scope of the embodiments of the present application.

Finally, it also should be noted that relational terms used herein such as first and second are only used to distinguish one entity or operation from another entity or operation, and do not necessarily require or imply any such actual relation or sequence between these entities or operations. Moreover, terms “include”, “contain” or any other variations thereof are intended to cover a non-exclusive inclusion, whereby a process, method, article, or terminals including a series of elements does not include only those elements but also other elements not expressly listed or also includes the intrinsic elements of the process, method, article, or terminals. Without further limitations, an element defined by the sentence “including a/an . . . ” do not exclude the presence of other same elements in the process, method, article or terminal device including the element.

The PCIe device detection system, method, apparatus, and product provided by the present application are described in detail above. The principle and embodiments of the present application are described herein with specific examples. The above embodiments are explained to help the understanding of the method and core concept of the present application. Meanwhile, for the ordinary skilled in the art, according to the concept of the present application, the embodiments and application ranges may be changed. In conclusion, the contents of the present application should not be construed as limiting the present application.

1. A peripheral component interconnect express device detection system, at least comprising a complex programmable logic device, the complex programmable logic device comprising:
a control unit, configured to obtain presence information transmitted by a peripheral component interconnect express device during a detection cycle, the presence information comprising presence signals of all presence detection pins on the peripheral component interconnect express device;
a parsing unit, configured to obtain all presence signals from the presence information, and determine an actual bandwidth of the peripheral component interconnect express device based on the presence signals; and
a determination unit, configured to determine whether the peripheral component interconnect express device tilts according to a preset bandwidth and the actual bandwidth.

2. The peripheral component interconnect express device detection system according to claim 1, wherein the complex programmable logic device further comprises a register, configured to store the presence information and the preset bandwidth; and
the parsing unit is further configured to determine a specification of the peripheral component interconnect express device according to a total number of the presence signals of the peripheral component interconnect express device; and take a factory bandwidth corresponding to the specification of the peripheral component interconnect express device as the preset bandwidth to be stored in the register.

3. The peripheral component interconnect express device detection system according to claim 1, wherein the parsing unit is configured to:
obtain a number of low-level presence signals among all presence signals; and
calculate the actual bandwidth of the peripheral component interconnect express device according to the number of low-level presence signals, a total number of the presence signals, and the preset bandwidth.

4. The peripheral component interconnect express device detection system according to claim 2, wherein the determination unit is configured to:
compare the actual bandwidth with the preset bandwidth;
determine that the peripheral component interconnect express device is in a bandwidth reduction state in response to the actual bandwidth being less than the preset bandwidth; and
determine that the peripheral component interconnect express device tilts in response to a high-level presence signal being detected, when the peripheral component interconnect express device is in the bandwidth reduction state.

5. The peripheral component interconnect express device detection system according to claim 2, wherein the control unit is configured to receive the presence information transmitted by the peripheral component interconnect express device during a plurality of consecutive detection cycles;
the parsing unit is configured to determine the actual bandwidth of the peripheral component interconnect express device during each of the plurality of consecutive detection cycles;
the determination unit is configured to compare the actual bandwidth of the peripheral component interconnect express device with the preset bandwidth during each of the plurality of consecutive detection cycles; determine that the peripheral component interconnect express device is in a bandwidth reduction state in response to the actual bandwidth being less than the preset bandwidth; and determine that the peripheral component interconnect express device tilts in response to a high-level presence signal being detected, when a duration during which the peripheral component interconnect express device is in the bandwidth reduction state reaches a first threshold.

6. The peripheral component interconnect express device detection system according to claim 4, wherein the control unit is further configured to generate a bandwidth alarm signal when the peripheral component interconnect express device is in the bandwidth reduction state; and generate a tilt release request signal when the peripheral component interconnect express device tilts.

7. The peripheral component interconnect express device detection system according to claim 4, wherein the complex programmable logic device further comprises a fault lighting unit;
the control unit is further configured to generate a fault lighting signal when the peripheral component interconnect express device is in the bandwidth reduction state, and transmit the fault lighting signal to the fault lighting unit; and
the fault lighting unit is configured to trigger a lighting alarm at a corresponding position according to the fault lighting signal.

8. The peripheral component interconnect express device detection system according to claim 1, wherein the control unit is further configured to:
configure a data acquisition instruction, the data acquisition instruction comprising a data load enable signal and a clock signal, the data acquisition instruction being configured to acquire the presence information of the peripheral component interconnect express device; and
transmit the data acquisition instruction to the peripheral component interconnect express device during one detection cycle, and receive the presence information transmitted by the peripheral component interconnect express device.

9. The peripheral component interconnect express device detection system according to claim 6, further comprising a baseboard management controller;
the control unit being further configured to store the bandwidth alarm signal and the tilt release request signal in the register; and
the baseboard management controller configured to read the bandwidth alarm signal and the tilt release request signal from the register, and generate an alarm prompt.

10. The peripheral component interconnect express device detection system according to claim 9, wherein the baseboard management controller is further configured to read the bandwidth alarm signal, the tilt release request signal, and all presence signals corresponding to a current detection cycle from the register, and record a peripheral component interconnect express fault log.

11. A peripheral component interconnect express device detection method, being applied to a peripheral component interconnect express device detection system,
the peripheral component interconnect express device detection system, at least comprising a complex programmable logic device, the complex programmable logic device comprising:
a control unit, configured to obtain presence information transmitted by a peripheral component interconnect express device during a detection cycle, the presence information comprising presence signals of all presence detection pins on the peripheral component interconnect express device;
a parsing unit, configured to obtain all presence signals from the presence information, and determine an actual bandwidth of the peripheral component interconnect express device based on the presence signals; and
a determination unit, configured to determine whether the peripheral component interconnect express device tilts according to a preset bandwidth and the actual bandwidth;
the method comprising:
acquiring the presence information of the peripheral component interconnect express device, the presence information comprising the presence signals of all the presence detection pins on the peripheral component interconnect express device;
obtaining all presence signals from the presence information, and determining the actual bandwidth of the peripheral component interconnect express device based on the presence signals; and
determining whether the peripheral component interconnect express device tilts according to the preset bandwidth and the actual bandwidth.

12. The peripheral component interconnect express device detection method according to claim 11, further comprising:
determining a specification of the peripheral component interconnect express device according to a total number of the presence signals of the peripheral component interconnect express device; and
obtaining a corresponding factory bandwidth according to the specification of the peripheral component interconnect express device, and taking the corresponding factory bandwidth as the preset bandwidth.

13. The peripheral component interconnect express device detection method according to claim 11, wherein the determining the actual bandwidth of the peripheral component interconnect express device based on the presence signals comprises:
obtaining a number of low-level presence signals among all presence signals; and
calculating the actual bandwidth of the peripheral component interconnect express device according to the number of low-level presence signals, a total number of the presence signals, and the preset bandwidth.

14. The peripheral component interconnect express device detection method according to claim 11, wherein the determining whether the peripheral component interconnect express device tilts according to the preset bandwidth and the actual bandwidth comprises:
comparing the actual bandwidth with the preset bandwidth;
determining that the peripheral component interconnect express device is in a bandwidth reduction state in response to the actual bandwidth being less than the preset bandwidth; and
determining that the peripheral component interconnect express device tilts in response to a high-level presence signal being detected when the peripheral component interconnect express device is in the bandwidth reduction state.

15. The peripheral component interconnect express device detection method according to claim 11, wherein the determining whether the peripheral component interconnect express device tilts according to the preset bandwidth and the actual bandwidth comprises:
obtaining the actual bandwidth of the peripheral component interconnect express device during a plurality of consecutive detection cycles;
comparing the actual bandwidth with the preset bandwidth during each of the plurality of consecutive detection cycles;
determining that the peripheral component interconnect express device is in a bandwidth reduction state in response to the actual bandwidth being less than the preset bandwidth; and
determining that the peripheral component interconnect express device tilts in response to a high-level presence signal being detected when a duration during which the peripheral component interconnect express device is in the bandwidth reduction state reaches a first threshold.

16. The peripheral component interconnect express device detection method according to claim 14, further comprising:
generating a bandwidth alarm signal when it is determined that the peripheral component interconnect express device is in the bandwidth reduction state;
generating a tilt release request signal when the peripheral component interconnect express device tilts; and
generating an alarm prompt based on the bandwidth alarm signal and the tilt release request signal.

17. The peripheral component interconnect express device detection method according to claim 14, further comprising:
generating a fault lighting signal when it is determined that the peripheral component interconnect express device is in the bandwidth reduction state; and
triggering a lighting alarm at a corresponding position according to the fault lighting signal.

18. The peripheral component interconnect express device detection method according to claim 12, further comprising obtaining the total number of the presence signals of the peripheral component interconnect express device comprises:
configuring a data acquisition instruction, the data acquisition instruction comprising a data load enable signal and a clock signal, the data acquisition instruction being configured for acquiring the presence information of the peripheral component interconnect express device;
transmitting the data acquisition instruction to the peripheral component interconnect express device during one detection cycle, and receiving the presence information transmitted by the peripheral component interconnect express device during the one detection cycle, the presence information comprising the presence signals of all the presence detection pins on the peripheral component interconnect express device; and
determining the total number of the presence signals of the peripheral component interconnect express device according to the presence information.

19. The peripheral component interconnect express device detection method according to claim 16, further comprising:
recording a peripheral component interconnect express fault log according to the bandwidth alarm signal, the tilt release request signal, and all presence signals corresponding to a current detection cycle.

20. (canceled)

21. A non-transitory computer-readable storage medium, having a computer program stored therein, wherein the computer program, when executed by a processor, implements steps in a peripheral component interconnect express device detection method being applied to a peripheral component interconnect express device detection system,
the peripheral component interconnect express device detection system, at least comprising a complex programmable logic device, the complex programmable logic device comprising:
a control unit, configured to obtain presence information transmitted by a peripheral component interconnect express device during a detection cycle, the presence information comprising presence signals of all presence detection pins on the peripheral component interconnect express device;
a parsing unit, configured to obtain all presence signals from the presence information, and determine an actual bandwidth of the peripheral component interconnect express device based on the presence signals; and
a determination unit, configured to determine whether the peripheral component interconnect express device tilts according to a preset bandwidth and the actual bandwidth;
the method comprising:
acquiring the presence information of the peripheral component interconnect express device, the presence information comprising the presence signals of all the presence detection pins on the peripheral component interconnect express device;
obtaining all presence signals from the presence information, and determining the actual bandwidth of the peripheral component interconnect express device based on the presence signals; and
determining whether the peripheral component interconnect express device tilts according to the preset bandwidth and the actual bandwidth.

22. (canceled)
